(19) United States
(12) Patent Application Publication
(10) Pub. No.: US 2026/0100851 A1
(43) Pub. Date: Apr. 9, 2026

(54) VERIFICATION OF DIGITAL CREDENTIALS AND DIGITAL SIGNATURES

(71) Applicant: TBCASOFT, INC., Sunnyvale, CA (US)

(72) Inventor: Kaibin HUANG, New Taipei (TW)

(21) Appl. No.: 19/113,905

(22) PCT Filed: Sep. 21, 2022
(86) PCT No.: PCT/US22/76823

§ 371 Date: Mar. 20, 2025

(51) Int. Cl. H04L 9/32; H04L 9/08

(52) U.S. Cl. CPC H04L 9/3268; H04L 9/0825; H04L 9/3218; H04L 9/3247; H04L 9/3271

(57) ABSTRACT

Disclosed in the present invention include methods and systems for issuing a certificate-type credential and electronically signing a document. Both applications require to verify if a digital credential of a prover or a signer is authenticated. Authentication of the digital credential requires a two-fold verification that the digital credential is verified to be valid and one of at least one issuer linked to the digital credential according to a parent-child relationship is verified to be trusted. To verify that the digital credential is valid, validity of a proof, expiration date, and revocation information associated with the digital credential should all be verified to be valid. The two-fold verification secures more for digital credential verification. Non-certificate type digital credentials and certificate-type digital credential can be organized in a digital identity hierarchy allowing ownership of multiple digital credentials to one entity implemented with distributed ledger technology effectively avoiding single point of failure.

### BACKGROUND OF THE INVENTION

### 1. Field of the Invention

The present invention relates to a method and system for verifying credentials and signatures, and, more particularly, to a method and system for verifying the digital signature and the digital credential of a signer upon signing a document and of a prover requesting for a certificate-type digital credential.

### 2. Description of the Related Art

A certificate authority (CA) is an organization that acts to validate identities and bind them with cryptographic key pairs to digital certificates. Being the most commonly employed web public key infrastructures (PKIs) approach, any issuing entity in the CA is an entity that issues digital certificates which certify the ownership of public keys by the named subjects of the certificates. Generally, a CA hierarchy starts with a root CA at the top. Under the root CA sit a number of intermediate CAs. The Root CA will issue the intermediate CA certificate. The intermediate CA will then issue another CA, one layer down, or sign end entity certificates.

What the CA does is that it functions as a trusted third party that authenticates public keys for a network of entities. Most web services are secured through the keys signed by the CA.

As a result of the exclusively-dominating trusted hierarchy, the CA hierarchy has problems and limitations that the online identities of entities in the CA hierarchy need to be certified by CA or the intermediate CAs in the CA hierarchy, sometimes private companies and governments. There is another problem that before issuing certificates to an entity/organization, the CA has to do the entity/organization identification in person to ensure that the entity/organization who they're certifying to is actually the one who claims the certificate. Such step is usually called know-your-customer (KYC) process. Traditionally, when an entity/organization has to apply for more than one certificate from different CAs, the KYC process must be repeated for applications to the different CAs. Moreover, such centralized trusted hierarchy is vulnerable to a single-point of failure which takes place at one of the intermediate CAs and the end entities and can have catastrophic consequences when compromised, as demonstrated by the DigiNotar case.

### SUMMARY OF THE INVENTION

An objective of the present invention is to provide multiple methods and a system for issuing a digital certificate and electronically signing a document capable of eliminating the KYC process for CA certificates and the single point of failure and enhancing security for verification of digital identities.

To achieve the foregoing objective, a method for issuing a digital credential of a certificate type includes:
a certificate-issuing entity receiving a request for the digital credential of the certificate type from a certificate-requesting entity, in which the request for the digital credential of the certificate type includes a public key generated by the certificate-requesting entity;
the certificate-issuing entity sending the certificate-requesting entity a request for an existing digital credential of the certificate-requesting entity;
the certificate-issuing entity sending the certificate-requesting entity a request for an existing digital credential of the certificate-requesting entity;
the certificate-issuing entity verifying if the existing digital credential is authenticated and the certificate-requesting entity is authentic for endorsing the existing digital credential and, when verifying that the existing digital credential is authenticated and the certificate-requesting entity is authentic for endorsing the existing digital credential, generating the digital credential of the certificate type including the public key of the certificate-requesting entity; and
the certificate-issuing entity sending the digital credential of the certificate type to the certificate-requesting entity.

In one embodiment, to verify if the existing digital credential is authenticated and the certificate-requesting entity is authentic for endorsing the existing digital credential, the method further includes:
initializing a current credential and a current credential owner to the existing digital credential and the certificate-requesting entity respectively;
determining if the current credential is valid;
when determining that the current credential is valid, determining if an issuer that issues the current credential is available in a digital credential hierarchy and trusted, wherein the issuer is M layer under a credential administrator in the digital credential hierarchy, where M is an integer greater than 0, the issuer is at a next layer above the current credential owner, and owns a digital credential issued by another issuer at a next layer above the issuer, and the credential administrator is at a top layer of the digital credential hierarchy;
when determining that the issuer is available in the digital credential hierarchy but not trusted, replacing the current credential owner and the current credential with the issuer and a digital credential of the issuer respectively and resuming determining if the current credential is valid;
when determining that the issuer is available in the digital credential hierarchy and trusted, determining that the existing digital credential is authenticated and performing determining if the certificate-requesting entity is authentic for endorsing the existing digital credential;
when determining that any determination result of determining if the current credential is valid and determining if an issuer that issues the current credential is available in the digital credential hierarchy and trusted fails, determining that the existing digital credential is not authenticated; and
when determining that the existing digital credential is authenticated, determining if the certificate-requesting entity is authentic for endorsing the existing digital credential.

To achieve the foregoing objective, a method for electronically signing a document includes:
a credential-verifying entity sending a request for a proof of a signer digital credential of a document-signing entity to the document-signing entity and receiving the proof of the signer digital credential from the document-signing entity, in which the proof includes a signer public key associated with the signer digital credential;
the credential-verifying entity verifying if the signer digital credential is authenticated and, when verifying that the signer digital credential is valid, sending a document to the document-signing entity; and
the credential-verifying entity receiving the document signed by a signer private key paired with the signer public key and the signer public key from the document-signing entity and verifying if the document is signed by the document-signing entity with the signer public key.

In one embodiment, to verify if the signer digital credential is authenticated, the method further includes:
initializing a current credential and a current credential owner to the signer digital credential and the document-signing entity;
determining if the current credential is valid;
when determining that the current credential is valid, determining if an issuer that issues the current credential is available in a digital credential hierarchy and trusted, wherein the issuer is M layer under a credential administrator in the digital credential hierarchy, where M is an integer greater than 0, the issuer is at a next layer above the current credential owner, and owns a digital credential issued by another issuer at a next layer above the issuer, and the credential administrator is at a top layer of the digital credential hierarchy;
when determining that the issuer is available in the digital credential hierarchy but not trusted, replacing the current credential owner and the current credential with the issuer and a digital credential of the issuer respectively and resuming determining if the current credential is valid;
when determining that the issuer is available in the digital credential hierarchy and trusted, determining that the signer digital credential is authenticated; and
when determining that any determination result of determining if the current credential is valid and determining if an issuer that issues the current credential is available in the digital credential hierarchy and trusted fails, determining that the signer digital credential is not authenticated.

As reflected by the foregoing description, each of the method adopts a two-fold verification technique of verifying if a digital credential, regardless of if it is a cert-type credential or a non-cert credential, is valid and verifying if an issuer linked to the digital credential according to a parent-child issuing relationship is trusted. As the two-fold verification technique can be taken as the pre-requisite of applications for issuing a cert-type credential and verifying a signed document, the KYC process bothering the prover and the verifier in the applications repeatedly can thus be eliminated. Meanwhile, with the two-fold verification technique, the digital credentials can be verified in a more secure manner. Besides, the flexible choices of cert-type credentials or non-cert credentials for verification can in turn reflect that any entity can own multiple digital identities, possibly cert-type credentials, non-cert credentials, or both, in a digital credential hierarchy accommodating those cert-type credentials and non-cert credentials as a whole.

To achieve the foregoing objective, a system for issuing a digital credential of a certificate type and electronically signing a document includes a distributed ledger network, a first computing device, a second computing device, at least one issuer device, and a database.

The distributed ledger network maintains a distributed ledger storing revocation information associated with issued digital credentials.

The first computing device is communicatively connected to the distributed ledger network.

The second computing device is communicatively connected to the first computing device.

The at least one issuer device is provided and linked to a digital credential of the second computing device when a parent-child issuing relationship exists and, when provided, is communicatively connected to the first computing device. The parent-child issuing relationship exists when one of the at least one issuer device issues the digital credential to the second computing device and each of the remaining issuer device issues another digital credential to another one of the at least one issuer device.

The database is communicatively connected to the second computing device and the at least one issuer device and stores the issued digital credentials including the digital credentials of the second computing device and the at least one issuer devices that are respectively accessible to the second computing device and the at least one issuer device.

In view of the structural features for the first computing device to play the role of the certificate-issuing entity and the credential-verifying entity, the second computing device to play the roles of the certificate-requesting entity and the document-signing entity, and the at least one issuer device to fulfill the parent-child issuing relationship associated with the digital credential to be verified, the foregoing system enables itself to perform applications of issuing a digital certificate and electronically signing a document as indicated by the foregoing methods. Therefore, the improvements in terms of the KYC process taking effect with prover's existing credentials and enhanced security in verification of digital identities can be also beneficial from the system. As to the single point of failure, because the system is implemented on distributed ledger technology, the damage to the system caused by any single point of failure can be minimized without further impacting the portion of the system not compromised by the failure.

Other objectives, advantages and novel features of the invention will become more apparent from the following detailed description when taken in conjunction with the accompanying drawings.

### BRIEF DESCRIPTION OF THE DRAWINGS

FIG. 1 is a schematic diagram showing an embodiment of a digital identity hierarchy in accordance with the present invention;

FIG. 2 is a schematic diagram showing another embodiment of a digital identity hierarchy in accordance with the present invention;

FIG. 3 is a flow diagram showing verification of authenticity of a digital identity in accordance with the present invention;

FIG. 4 is a flow diagram showing a method for issuing a digital certificate in accordance with the present invention;

FIG. 5 is a flow diagram showing an embodiment of a method for electronically signing a document in accordance with the present invention;

FIG. 6 is a flow diagram showing another embodiment of a method for electronically signing a document in accordance with the present invention;

FIG. 7 is a schematic diagram showing network architecture of a first embodiment of a system for issuing a digital certificate and electronically signing a document in accordance with the present invention;

FIG. 8 is a schematic diagram showing network architecture of a second embodiment of a system for issuing a digital certificate and electronically signing a document in accordance with the present invention; and

FIG. 9 is a schematic diagram showing network architecture of a third embodiment of a system for issuing a digital certificate and electronically signing a document in accordance with the present invention.

### DETAILED DESCRIPTION OF THE INVENTION

The terminology used in the description presented below is intended to be interpreted in its broadest reasonable manner, even though it is used in conjunction with a detailed description of certain specific embodiments of the technology. Certain terms may even be emphasized below; however, any terminology intended to be interpreted in any restricted manner will be specifically defined as such in this Detailed Description section.

The embodiments introduced below can be implemented by programmable circuitry programmed or configured by software and/or firmware, or entirely by special-purpose circuitry, or in a combination of such forms. Such special-purpose circuitry (if any) can be in the form of, for example, one or more application-specific integrated circuits (ASICs), programmable logic devices (PLDs), field-programmable gate arrays (FPGAs), etc. In the following description the term of digital credential may be one digital credential, which is rephrased as non-certificate digital credential later, or one digital certificate, which is rephrased as certificate-type digital credential later, and an entity, such as a prover, a signer, an issuer, a verifier, a certificate-requesting entity, a certificate-issuing entity, a document-signing entity, or a credential-verifying entity, may be referred to a computing device, being one of a server, a desktop computer, a laptop computer, a smart device, a tablet PC, and the like.

The described embodiments concern one or more methods and systems for verifying a digital signature and a digital credential of a prover upon requesting for a certificate-type digital credential and signing a document and can primarily focus on a first subject for issuance of a certificate-type digital credential to a certificate-requesting entity and a second subject for verification of a document signed by a document-signing entity. A certificate-type digital credential for one entity is an electronic data structure from another trusted entity that guarantees the validity and authenticity of a public key that binds the entity, which may be an institution, a person, a computer program, a web address etc., to its public key and is the digital identifying proof that confirms an entity is what it says it is. To differentiate from the certificate-type digital credentials which are also called digital certificates conventionally, all other digital credentials can be termed as the non-certificate digital credentials. Regardless of the certificate-type digital credentials or the non-certificate digital credentials, in general, they are all digital credentials. Basically, the certificate-type digital credentials can be treated as a specific type of digital credentials. For sake of conciseness, the word ‘digital’ will be removed from the terms of ‘non-certificate digital credentials’, ‘certificate-type digital credentials’, and ‘digital signature’. Being a general term for both non-certificate credentials and certificate-type credentials, ‘digital credential’ can be also named with a simpler form of ‘credential’. The terms appearing with ‘certificate’ or ‘credential’ therein may be named with the abbreviation of ‘cert’ or ‘cred’ instead. Such abbreviation in naming is also applied to the entities dealing with request or issuance of cert-type credentials, such as cert-requesting entities for certificate-requesting entities. The mentioned naming rule will be applied hereafter. To issue a cert-type credential to a cert-requesting entity in the first subject, a cert-issuing entity needs to receive a proof generated according to an existing credential of the cert-requesting entity and a signature and a public key of the cert-requesting entity associated with the existing credential. The cert-issuing entity must verify if the existing credential is authenticated and the cert-requesting entity is an authentic signer endorsing the existing credential. In the first part of verifying if the existing credential is authenticated, a first step to check if the existing credential is valid requires that the proof associated with the existing credential be verified to be valid and the existing credential be neither expired nor revoked. A next step can then be started to verify if one of at least one issuer recursively traced and linked to the existing credential according to a parent-child issuing relationship is trusted to wrap up the verification for the first part. The parent-child issuing relationship defines that one of the at least one issuer issues the existing credential and each of the remaining issuer(s) issues another credential to another one of the at least one issuer. Such process for tracing the at least one issuer will go on till a trusted issuer or no issuer at all can be found. After a trusted issuer is identified, the existing credential is authenticated in the first part. In the second part for verifying if the cert-requesting entity is the authentic signer endorsing the existing credential, the cert-issuing entity should verify the signature of the cert-requesting entity generated for endorsing the existing credential with the public key of the cert-requesting entity. When verifications of the first and second parts for the existing credential are true, the cert-issuing entity generates the cert-type credential including the public key of the cert-requesting entity and then issues the cert-type credential to the cert-requesting entity. To verify a signed document in the second subject, a cred-verifying entity receives a proof generated based on a signer credential of a document-signing entity from the document-signing entity and verifies if the signer credential is authenticated. After the signer credential is authenticated, the cred-verifying entity then sends the document to the document-signing entity, receives the signed document from the document-signing entity, and verifies if the document is signed by the document-signing entity. To verify if the signer credential is authenticated, it is analogous to what was discussed earlier. In an alternative approach, the cred-verifying entity may send the document to the document-signing entity before the signer credential is verified. In that case, the cred-verifying entity verifies if the document is signed by the document-signing entity only after verifying that the signer credential is authenticated. A system involved with the first subject and the second subject includes a prover/signer, an issuer of a requested credential/verifier, at least one issuer involved with the parent-child issuing relationship, a database, and a distributed ledger network. Each of the prover/signer, the issuer of the requested credential/verifier, the at least one issuer involved with the parent-child issuing relationship may be a computing device.

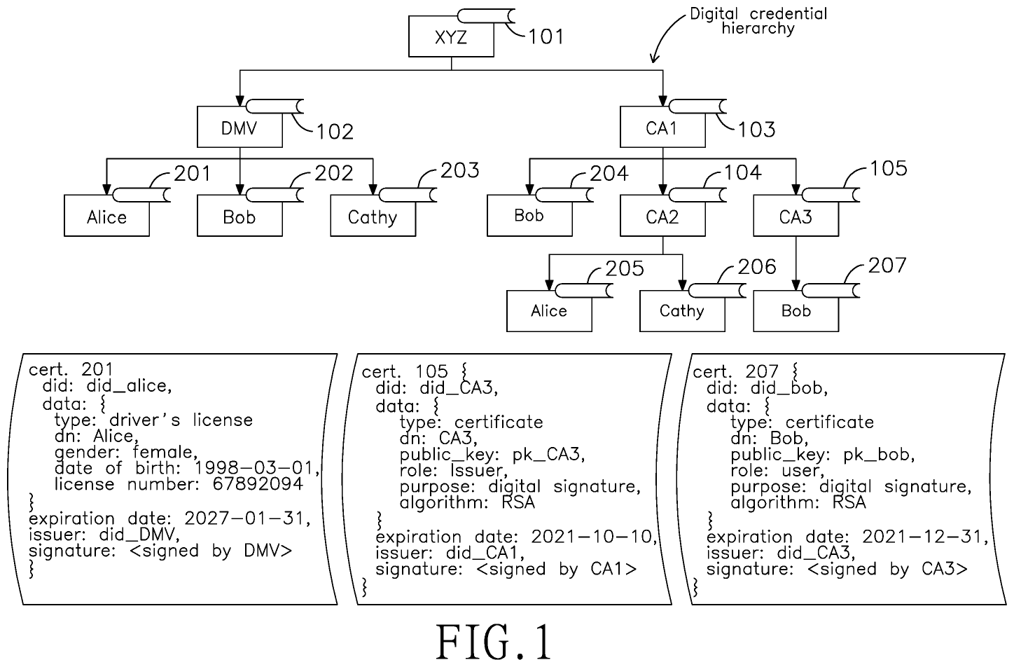

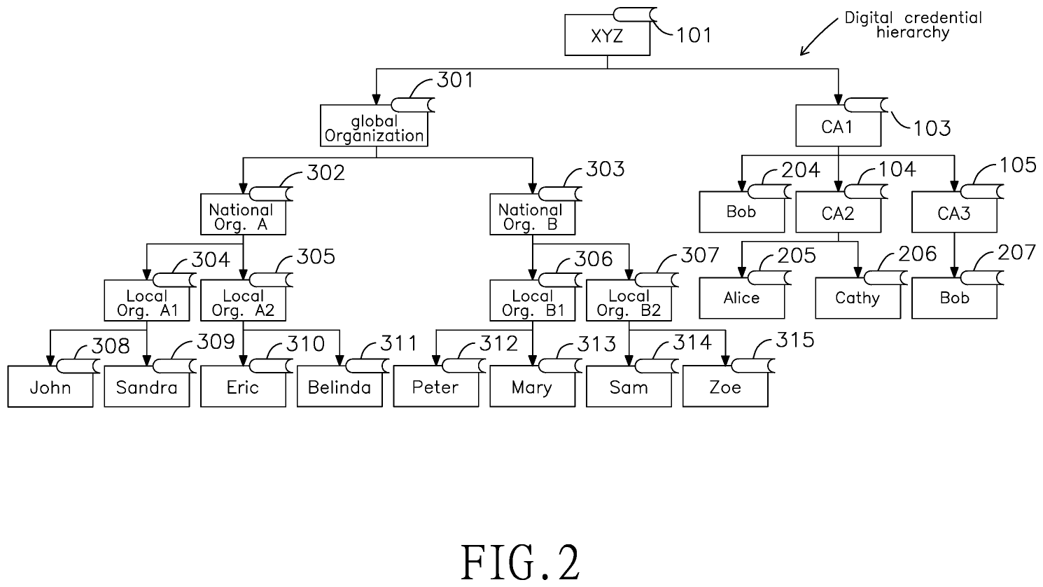

With reference to FIG. 1 illustrating an embodiment of a credential hierarchy, the credential hierarchy includes a root credential 101 owned by a credential administrator XYZ, multiple issuer credentials 102-105 each of which is owned by an issuer, and multiple user credentials 201-207 each of which is owned by a user. The root credential 101 is at a top layer of the credential hierarchy and the credential administrator XYZ issues a part of the multiple issuer credentials 102, 103 at a next layer below the layer of the root credential 101. The multiple issuer credentials 102-105 are at multiple layers respectively below the layer of the root credential 101 and the issuer of each issuer credential 102-105 issues at least one of the remaining issuer credentials 104, 105 or at least one of the multiple user credentials 201-207 each of which is at a corresponding next layer below a corresponding issuer credential 102-105. For example, the issuer credentials 102, 103 at a next layer below the layer of the root credential 101 are owned by corresponding issuers DMV, CA1 and are issued by the credential administrator XYZ, and the issuer credentials 104, 105 at a next layer below the layer of the issuer credential 103 are owned by corresponding issuers CA2, CA3 and are issued by the issuer CA1 owning the issuer credential 103. The multiple user credentials 201-207 are at multiple layers below the layers of corresponding issuer credentials 102-105. For example, the user credentials 201-203 at a next layer below the layer of the issuer credential 102 are owned by corresponding users, Alice, Bob, and Cathy, and are issued by the issuer DMV owning the issuer credential 102, the user credential 204 at a next layer below the layer of the issuer credential 103 is owned by a corresponding user Bob and is issued by the issuer CA1 owning the issuer credential 103, the user credentials 205, 206 at a next layer below the layer of the issuer credential 104 are owned by corresponding users, Alice and Cathy, and are issued by the issuer CA2 owning the issuer credential 104, and the user credential 207 at a next layer below the layer of the issuer credential 105 is owned by a corresponding user Bob and is issued by the issuer CA3 owning the issuer credential 105. As it turns out, the issuers in the credential hierarchy are entitled to issue corresponding issuer credentials or user credentials while the users owing the user credentials in the credential hierarchy are not entitled to issue any credential to anyone. Moreover, in the credential hierarchy, multiple credential systems, each of which is related to the issuer credentials and the user credentials for a specific purpose, are allowed. As shown in FIG. 1, the credential hierarchy includes but is not limited to one DMV system and one CA system. The DMV system and the CA system include the issuer credential(s) and the user credentials for the purpose of driver licenses and CA certificates. Typically, the issuer credentials and the user credentials of the CA system pertain to cert-type credentials while those of the DMV system pertain to non-cert credentials. It is likely that each credential system may have the issuer credentials at more than one layer of the credential system. In that scenario, traversing downwards from a layer on top of the credential system, any issuer at each layer may issue at least one issuer credential to at least one other issuer respectively, or issue at least one user credential to at least one user respectively, or issue nothing at all at a next lower layer of the credential system. An embodiment of a credential system with the issuer credentials at multiple layers of the credential system is shown in FIG. 2. What FIG. 2 illustrates is a credential system including an issuer credential 301 which is issued to an issuer for a global organization by the credential administrator XYZ, two issuer credentials 302, 303 which are issued to two issuers for two national organizations A and B by the issuer for the global organization, four issuer credentials 304-307 two of which are respectively issued to two issuers for two local organizations A1, A2 by the issuer for the national organization A and two others of which are respectively issued to two issuers for two local organizations B1, B2 by the issuer for the national organization B and eight user credentials 308-315 two of which are respectively issued to two users John, Sandra by the issuer for the local organization A1, another two of which are respectively issued to two users Eric, Belinda by the issuer for the local organization A2, yet another two of which are respectively issued to two users Peter, Mary by the issuer for the local organization B1, the remaining of which are respectively issued to Sam and Zoe by the issuer of the local organization B2. The issuer credentials and the user credentials in the credential system illustrated in FIG. 2 may be cert-type credentials or non-cert credentials. The issuer credential 301 owned by the issuer for the global organization is at a next layer below that of the root credential 101. The issuer credentials 302, 303 owned by the issuers for the national organizations A, B are at a next layer below that of the issuer certificate for the global organization 301. The issuer credentials 304-307 owned by the issuers for the local organizations A1, A2, B1, B2 are at a next layer below those of the issuer certificates 302, 303 for the national organizations A and B. The user credentials 308-314 are at a next layer below those of the issuer certificates 304-307 for the local organizations. Basically, there is only one issuer credential for the issuer like the global organization in such credential system. However, the numbers of the issuer credentials for the issuers like the national organizations and the local organizations and the user credentials for the users may vary from credential system to credential system.

The credential administrator is entitled to issue both non-cert credentials and cert-type credentials. The issuers and users in the credential hierarchy may play the role of one of the cert-requesting entity in the first subject and the cred-verifying entity and the document-signing entity in the second subject. However, only the issuers issuing cert-type credentials in the credential hierarchy can play the role of the cert-issuing entity in the first subject. Because each credential in the credential hierarchy is owned by a corresponding entity, i.e. one of the credential administrator, an issuer, and a user, the credential and the corresponding entity that can be equivalently referred to a same identity in the credential hierarchy may be interchangeably selected for the same identity. It is noted that the same user Bob in FIG. 1 may have different issuer credentials 202, 204, 207 in the credential hierarchy, which are respectively issued by the issuer DMV, the issuer CA1, and the issuer CA3. In the event that some credentials of any entity are compromised, the entity can still use other uncompromised credentials to prove his/her/its identity.

Though not exactly the same in the data fields, as far as verification of credentials is concerned, cert-type credentials and non-cert credentials can be treated the same as they have common data fields required for their verification and only differ from each other in terms of the remaining data fields. The common data fields which can be referred to cert-type credentials 105, 207 and non-cert credential 201 as shown in FIG. 1 include decentralized identifier (DID) of the credential, the expiration date of the credential, and the public key and the signature of the issuer and somehow explain the reason why the credential hierarchy can accommodate both cert-type credentials and non-cert credentials therein. In addition to the common data fields available to cert-type credentials and non-cert credentials, each cert-type credential further includes the following remaining data fields:
type: The type is set to “certificate”. This is the data field that differentiates cert-type credentials from non-cert credentials which usually have other types differing from “certificate”.
dn: The distinguished name of the owner of the cert-type credential for example, a user name, such as ‘Bob’ for the cert-type credential 207, or a company name. The distinguished name may not be a unique name.
public_key: The public key of the owner of the cert-type credential, which is used to verify any message or document which is signed by a private key of the owner of the cert-type credential paired with the public key.
role: It is the role of an issuer or a user depending on whether the cert-type credential is an issuer credential or a user credential. The owner of the cert-type credential may be one of an issuer, a prover, and a verifier when the role in the cert-type credential is issuer and may be one of a prover and a verifier when the role in the cert-type credential is user.
purpose: It indicates the purpose of the public key of the owner of the cert-type credential, usually one for digital signature or for data encryption.
algorithm: The cryptographic algorithm of digital signature or data encryption. For digital signature, RSA and ECDSA are commonly used. For data encryption, RSA is the most widely used one.

In contrast to the fixed remaining data fields for the cert-type credentials, the remaining data fields of the non-cert credentials may be flexible to adapt to different needs for identifying owners of the non-cert credentials. When digital driver's licenses issued by the DMV are the non-cert credentials, the remaining data fields of each digital driver license may include the following data fields:
type: Driver's license. Unlike the type specified as ‘certificate’ for cert-type credentials, the types of non-cert credentials specify their respective types into which the non-cert credentials are classified so as to reflect a variety of identification purposes for the non-cert credentials. Non-limiting examples of the type may include digital social security card, digital passport, digital company identification badge, digital diploma, and the like.
dn: The distinguished name of the owner of the non-cert credential. As illustrated in FIG. 1, the distinguished name of the driver's license for Bob 202 is ‘Bob’. The distinguished name may not be a unique name. For example, it is likely that there are multiple driver licenses whose distinguish names are ‘Michael Jordon’ or ‘Brenda Lee’.
gender: Gender of the owner of the non-cert credential, either male or female.
date of birth: The date when the credential owner was born.
license number: An alpha/numeric number with multiple digits, which is taken as identification card number in some countries, in the example of the driver's license for Alice 201, 67892094.

Because the system involved with the first subject may include a distributed ledger network maintaining the distributed ledger, information concerning the credential can be issued in both off-chain and on-chain manners. In the off-chain part, the cert-issuing entity in the system issues cert-type certificates and stores them on the computing devices of the cert-requesting entity, agents or proxies depending on various situations. In the on-chain part, the revocation information for keeping track of revocation status of credentials in the distributed ledger is published to the distributed ledger. Such revocation information will be updated when the private key of the owner of any credential has been discovered weak or compromised or the owner of the credential violates the regulations of the credential hierarchy. The owner of the credential may make a request to the issuer who issues the credential for revoking the credential of the owner and it is always that the related issuer is capable of revoking a credential and updating the related revocation information. A reason is required to justify certificate revocation and may be one of the cases including compromised key for the credential or for the related issuer, termination or resignation of the credential owner, re-issue of the credential, temporary revocation, decommission of the related issuer, and the like.

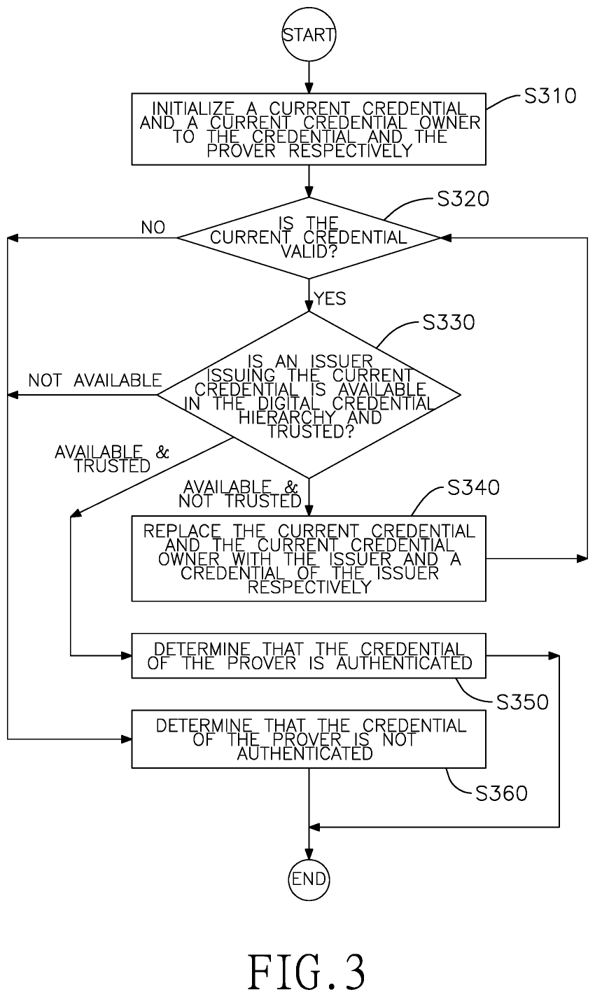

Owing to its involvement in the first and second subjects and a critical technique of the present invention as well, verification of authenticity of a credential has its priority to be introduced first. When it comes to the verification of a credential owned by a prover which may be one of the cert-requesting entity in the first subject and the document-signing entity in the second subject, a verifier which may be one of the cert-issuing entity in the first subject and the cred-verifying entity in the second subject verifies if the credential is authenticated. FIG. 3 illustrates the verification of authenticity of a credential with the following steps.

Step S310: Initialize a current credential and a current credential owner to the credential and the prover respectively. An issuer-tracing process is used to verify if the credential of the prover is authenticated. In the issuer-tracing process, each of at least one issuer at one or more layers above that of the prover in the credential hierarchy needs to be recursively traced according to the parent-child issuing relationship in a direction from the prover to an issuer at a layer below that of the credential administrator until the credential of one of the traced issuers or none of the credentials of the traced issuers is verified to be valid. In the beginning of the issuer-tracing process, the current step serves as initialization of the issuer-tracing process to define the current credential and the current credential owner as the credential of the prover and the prover respectively.

Step S320: Determine if the current credential is valid. To verify that the current credential is valid, three conditions must be met. First, a proof generated according to the current credential should be verified to be valid. Second, the current credential should not be expired. Third, the current credential has not been revoked. To be qualified for a valid current credential, the three conditions should all be met. Any one of the three conditions fails, the current credential is determined to be invalid. The proof for the current credential is generated by the current credential owner according to the current credential, knowledge of the current credential owner concerning the data fields of the current credential, and a verification requirement document (VRD) from the verifier. More details about VRD can be referred to the patent application PCT/US20/56388, entitled “VERIFICATION REQUIREMENT DOCUMENT FOR CREDENTIAL VERIFICATION”. The VRD specifies three kinds of data in the current credential, namely, a public part, a challenged part, and a private part, in which at least one of the public part and the challenged part is available and the private part is of privacy concern and is therefore not for verification. Thus, the proof of the current credential which focuses on the public part and the challenged part, if both are available, may include at least one public field, at least one signature of the respective public field, a public key of the issuer of the current credential, and at least one zero-knowledge proof challenging at least one challenged field included in the challenged part according to the VRD. It is only the at least one public field and the at least one signature of the respective public field that are present in the proof when the public part is specified in the VRD alone. It is only the at least one zero-knowledge proof that is present in the proof when the challenged part is specified in the VRD alone. The at least one signature of the respective public field is signed by the issuer, and can be verified with the public key of the issuer. A technique involved with the generation of the digital signature of a partial data fields of a credential is called Camenisch-Lysyanskaya (CL) signature, which allows the current credential owner to create the at least one signature of the respective public field of the credential without knowledge of a private key of the issuer as long as the signature of the issuer for signing the entire data fields of the credential is available. Such technique of the CL signature allows the verifier to verify the at least one signature of the respective public field of the current credential with the public key of the issuer. Each of the at least one zero-knowledge proof is to challenge one of the at least one challenged field and is computed through the current credential, the value of the challenged field, and a challenge condition from the VRD. Each challenge condition includes a comparison operator, such as >, <, >=, <=, =, and ≠, tested against a corresponding challenged field for the prover to prove if the challenged condition is met. Each of the at least one zero-knowledge proof is verified to be true when the challenged condition of the zero-knowledge proof is met. What it takes to verify that the current credential is valid requires that both or either one of the at least one signature of the respective public field and the at least one zero-knowledge proof be verified to be true depending on the availability of the public part and the challenged part in the VRD. Take a driver's license below as an example for verification of the current credential. If the VRD specifies the public fields of the public part including dn, gender, and license number in the driver's license and two zero-knowledge proofs, namely, Age >18 and not expired before Dec. 31, 2020 challenging the challenged fields of date of birth and expiration date respectively, the current credential owner will output three signatures of the public fields of dn, gender, and license number, which are signed by the issuer, and provide the three public fields, the three signatures, the public key of the issuer, which is owned by DMV, and the two zero-knowledge proofs challenging the challenged fields of date of birth and expiration date, to the verifier. If the values of the challenged fields, date of birth and expiration date, are Aug. 8, 2000 and Feb. 17, 2025, after verifying that the three signatures for the three public fields of dn, gender, and license number and the two zero-knowledge proofs are true, the verifier verifies that the proof of the driver's license provided by the current credential owner is valid.

The second condition and the third condition are applicable to a credential regardless of a non-cert credential or a cert-type certificate. The second condition for verifying if a credential is expired involves verification of the data field ‘expiration date’ in the credential. As for the third condition for verifying the credential, the verifier in communication with the distributed ledger network can access revocation information for the credential in the distributed ledger and verify whether the credential has been revoked or not according to the revocation information.

When determining that the digital credential is valid, perform step S330. Otherwise, perform step S360.

Step S330: Determine if an issuer that issues the current credential is available in the credential hierarchy and trusted. The issuer that issues the current credential is M layer under the credential administrator in the credential hierarchy, where M is an integer greater than 0. The issuer is at a next layer above the current credential owner, and owns a credential issued by another issuer at a next layer above the issuer. It is known that the credential administrator is at a top layer of the digital credential hierarchy. For verifying the current credential to be authenticated, not only should the current credential itself be verified to be valid, but an issuer recursively traced in the credential hierarchy according to the issuer-tracing process and issuing the current credential should be also determined to be trusted. When the issuer issuing the current credential is not available in the credential hierarchy, perform step S360. This is the situation when there is no issuer that can be found in the credential hierarchy to issue the current credential. To be a trusted or untrusted issuer, in one embodiment, the issuer may be found in a pre-approved list or not. When the issuer is determined to be available in the credential hierarchy and trusted, perform step S350. When the issuer is determined to be available in the credential hierarchy but not trusted, perform step S340.

Step S340: Replace the current credential owner and the current credential with the issuer and a credential of the issuer respectively and resume the step S320. The current step iteratively resumes the foregoing step S320 to verify if the current credential is valid after the current credential and the current credential owner get replaced.

Step S350: Determine that the credential of the prover is authenticated and exit. After verifying that the current credential abides by the three conditions and the availability of a trusted issuer through the issuer-tracing process, the verifier determines that the credential of the prover is authenticated without proceeding step S360.

Step S360: Determine that the credential of the prover is not authenticated. The credential of the prover is determined to be unauthenticated possibly because any of the three conditions is not met or a trusted issuer is not found in the issuer-tracing process.

The authenticity of the credential of the prover requires that all the results which are performed in any round of the verification loop represented by steps S320-S340 turn out to be positive. When all the verification results of steps S320-S340 are positive in the first round of verification, it means that the credential of the prover is valid and the issuer of the credential of the prover at a next layer right above the prover in the credential hierarchy is trusted. However, if the result of step S330 shows that the issuer is available in the credential hierarchy but is not trusted, a recursive loop that performs step S340 and then resumes step S320 will be started to trace a next issuer at a next layer above the issuer and then conduct a new round of the verification through steps S320-S340 to determine if the credential of the next issuer is valid and the next issuer is trusted. By default, each issuer at a top layer of a corresponding credential system in the identity hierarchy, such as DMV and CA1 in FIG. 1, is trusted. Given the verification of user credential 207 in FIG. 1 as an example, suppose the verification in the first round turns out to be that the user credential 207 is valid and issuer CA3 issuing the user credential 207 is not trusted. If the verification in the second round turns out to be that the issuer credential 105 of issuer CA3 is valid and issuer CA1 is trusted by default, the verification results of the example tell that user credential 207 of user Bob is verified to be authenticated in two rounds.

The first subject and second subject can be implemented with the technique introduced for verification of credentials. Besides verification of an existing credential of the cert-requesting entity, the first subject relating to the issuance of a cert-type credential to the cert-requesting entity needs to further verify something else for additionally endorsing its request for issuance of the cert-type credential. The something else may be a digital signature of the cert-requesting entity.

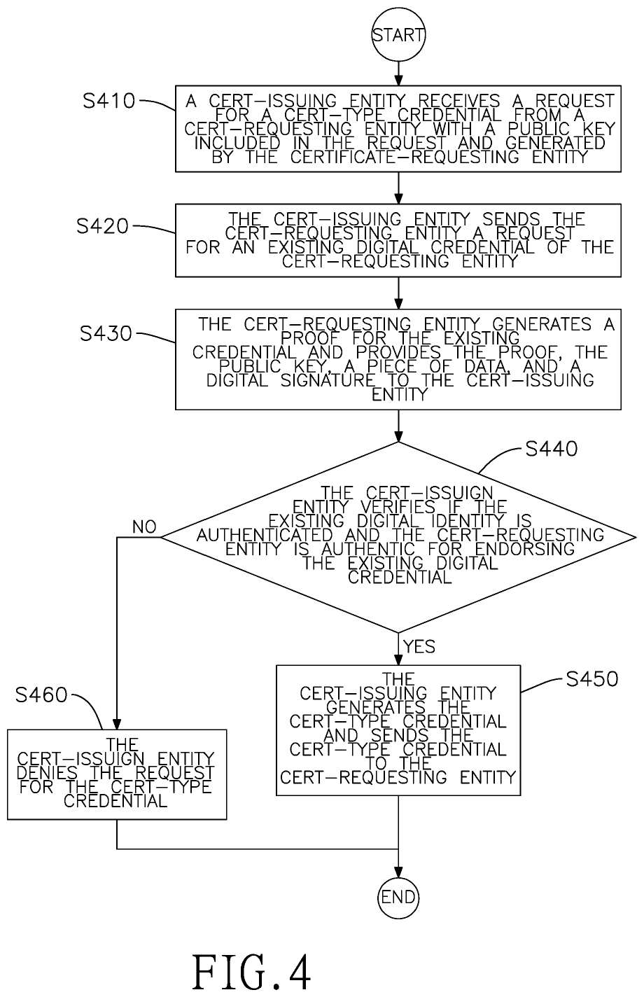

With reference to FIG. 4, to address the first subject, a method for issuing a cert-type credential includes the following steps.

Step S410: A cert-issuing entity receives a request for the cert-type credential from a cert-requesting entity. There are two parties involved in the present method. The cert-requesting entity is one of the two parties that makes a request for receiving a cert-type credential. The cert-issuing entity is the other party that verifies the qualification of the cert-requesting entity and judges whether the cert-requesting entity is qualified to receive the cert-type credential issued by the cert-issuing entity. Both the cert-requesting entity and the cert-issuing entity may be computing devices in communication with each other. The request for the cert-type credential is initiated by the cert-requesting entity, includes a public key, and is forwarded to the cert-issuing entity. The public key pertains to a part of one key pair generated by the cert-requesting entity according to public key cryptography and paired with a private key of the key pair.

Step S420: The cert-issuing entity sends the cert-requesting entity a request for an existing credential of the cert-requesting entity. In response to the request for the cert-type credential, the cert-issuing entity sends the request demanding for the existing credential to the cert-requesting entity. The existing credential may be a non-cert credential or a cert-type credential owned by the cert-requesting entity. In one embodiment, when the existing credential is a non-cert credential, the non-cert credential is one of official ID credentials, such as one of a digital driver license, a digital passport, a digital national ID card, and a digital state ID card. The type of the existing credential may be designated by the cert-issuing entity in its request.

Step S430: The cert-requesting entity generates a proof for the existing credential and provides the proof, the public key, a piece of data, and a digital signature to the cert-issuing entity. The proof for the existing credential is provided for verifying if the existing credential is authenticated and includes the foregoing data for validating a credential as mentioned in step S320. The piece of data may be a piece of random data which is generated by the cert-issuing entity individually or both the cert-issuing entity and the cert-requesting entity, and is signed by the private key of the key pair in generation of the signature. In other words, the piece of data can be generated with the individual effort of the cert-issuing entity or the effort of both the cert-issuing entity and the cert-requesting entity. The public key here serves to verify if the signature is signed by the cert-requesting entity. Thus, given the signature, the public key, and the piece of data, and the proof for the existing credential, an endorsement of the request for issuing the cert-type credential can then be provided.

Step S440: The cert-issuing entity verifies if the existing credential is authenticated and the cert-requesting entity is authentic for endorsing the existing credential. As for verification of the existing credential, steps S310-S360 can be referred to for the details. To verify if the cert-requesting entity is authentic for endorsing the existing credential, the cert-issuing entity uses the public key to verify whether the signature is signed by the cert-requesting entity. When verifying that the existing credential is authenticated and the cert-requesting entity is authentic for endorsing the existing credential, perform step S450. Otherwise, perform step S460.

Step S450: The cert-issuing entity generates the cert-type credential and sends the cert-type credential to the cert-requesting entity. The cert-type credential issued to the cert-requesting entity includes the public key of the key pair. Depending on different applications, the cert-issuing entity may send the cert-type credential elsewhere, such as a computing device of a proxy or an agent, for storage.

Step S460: The cert-issuing entity denies the request for the cert-type credential.

An example is given in the following for issuance of a cert-type credential for a club membership. When a computing device of a club membership issuing company which acts as the cert-issuing entity and is named as membership issuer hereinafter receives a request for a cert-type credential of a club membership from a computing device of an applicant which acts as the cert-requesting entity and is named as applicant hereinafter, the membership issuer sends a request for a digital driver's license to the applicant. The request for the club membership also includes a public key of a key pair generated by the applicant and paired with a private key of the key pair. In response to the request for a digital driver's license, the applicant generates a proof for the digital driver's license and sends the public key of the key pair, the signature, the piece of data, and the proof to the membership issuer. After verifying that the digital driver's license is authenticated and the applicant signs the piece of data with the public key of the key pair, the membership issuer generates the cert-type credential of the club membership, which includes the public key, for the applicant and sends the cert-type credential to the applicant.

The second subject verifies if a document is signed by a document-signing entity under the premise that a signer credential provided by the document-signing entity is verified by a cred-verifying entity to be authenticated or not first. It appears that the first subject and the second subject can be considered as applications requiring verification of both credential and digital signature. Both the first and second subjects can be likely linked by verifying the signed document in the second subject with the cert-type credential which is not initially available and can be acquired from the first subject if the cert-type credential is designated by the cred-verifying entity in the second subject. For example, a CA certificate that is requested for verification before verifying a digital signature of a document for loan application in the second subject can be acquired from the first subject with an existing credential, such as a digital driver's license, under the circumstance that the cert-requesting entity in the first subject also play the role of the document-signing entity in the second subject.

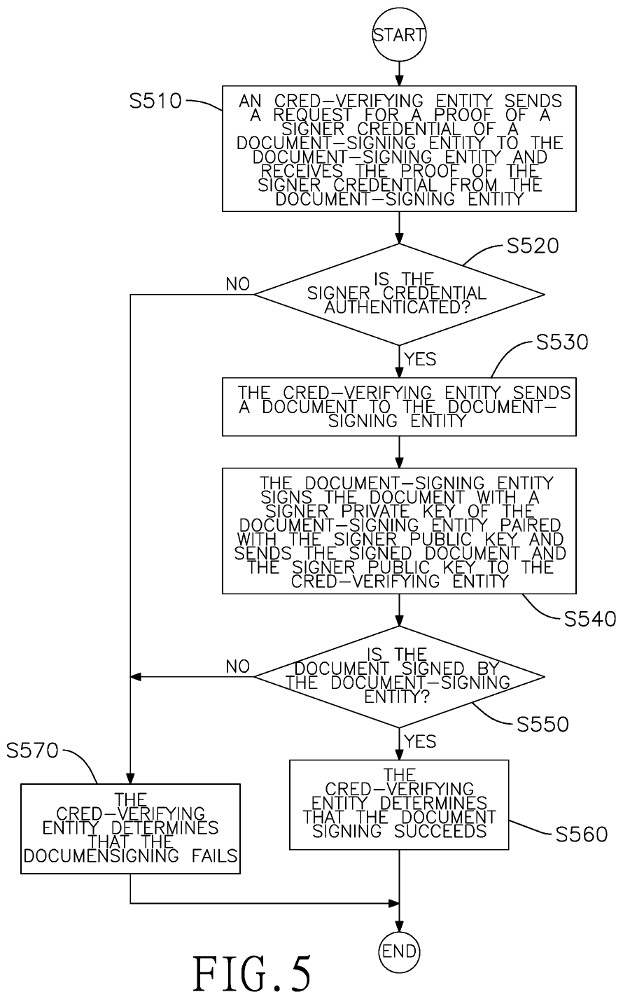

As shown in FIG. 5, a first embodiment of a method for electronically signing a document includes the following steps.

Step S510: A cred-verifying entity sends a request for a proof of a signer credential of a document-signing entity to the document-signing entity and receives the proof of the signer credential from the document-signing entity. The cred-verifying entity serves to send the request for the proof of the signer credential to the document-signing entity. The cred-verifying entity serves to receive the proof, verifies the signer credential of the document-signing entity, and judges whether the document-signing entity is a qualified signer of a document. Both the cred-verifying entity and the document-signing entity may be computing devices in communication with each other. The proof of the signer credential is prepared by the document-signing entity and subsequent verification of the proof in later steps serves as a condition to proceed with the document signing. The proof includes a signer public key acquired from the signer credential. The signer credential may be a non-cert credential or a cert-type credential owned by the document-signing entity. In one embodiment, when the signer credential is a non-cert credential, the non-cert credential is an official ID non-cert credential being one of a digital driver license, a digital passport, a digital national ID card, and a digital state ID card. The type of the signer credential may be designated by the cred-verifying entity beforehand to correspond to that of a document with a signature to be verified. For example, a digital driver's license or a CA certificate is requested for verifying a digital signature signed on an application form for getting a medical report.

Step S520: The cred-verifying entity verifies if the signer credential is authenticated. Similarly, steps S310-S360 can be referred to for the details of verifying if the signer credential is authenticated. When the signer credential is verified to be authenticated, perform step S530. Otherwise, perform step S570.

Step S530: The cred-verifying entity sends a document to the document-signing entity. In the present embodiment, the cred-verifying entity sends the document to the document-signing entity only after the signer credential is verified to be authenticated.

Step S540: The document-signing entity signs the document with a signer private key of the document-signing entity paired with the signer public key and sends the signed document and the signer public key to the cred-verifying entity. In one embodiment, the document is signed by the signer private key associated with a signer decentralized identifier (DID) of the document-signing entity in one of the data fields of the signer credential when the signer credential is a non-cert credential. In another embodiment, the document is signed by the signer private key, which is paired with a public key in one of the data fields of the signer credential, when the signer credential is a cert-type credential.

Step S550: After receiving the signed document and the signer public key, the cred-verifying entity verifies if the document is signed by the document-signing entity with the signer public key. The signer public key may be linked to the signer decentralized identifier (DID) of the document-signing entity in the signer credential when the signer credential is a non-cert credential or the public key in the signer credential when the signer credential is a cert-type credential. When the verification result is positive, perform step S560. Otherwise, perform step S570.

Step S560: The cred-verifying entity determines that the document signing succeeds.

Step S570: The cred-verifying entity determines that the document signing fails.

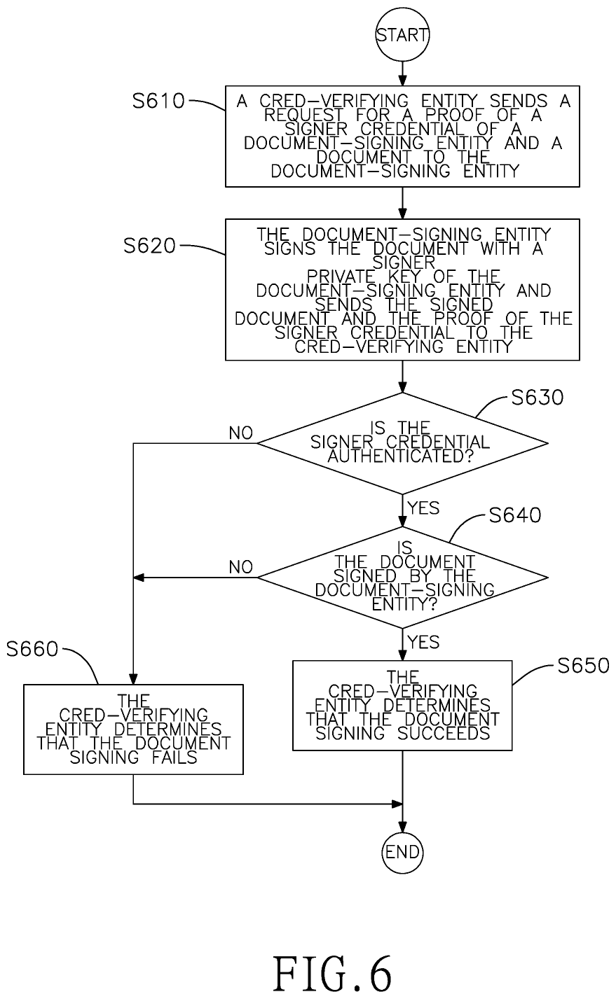

Unlike the foregoing first embodiment which sends the document to be signed after the signer credential is authenticated, with reference to FIG. 6, a second embodiment of a method for electronically signing a document which alternatively sends the document before the signer credential is verified to be authenticated includes the following steps. For avoidance of duplication, similar description to the first embodiment is not repeated in the second embodiment.

Step S610: A cred-verifying entity sends a request for a proof of a signer credential of a document-signing entity and a document to the document-signing entity. It is noted that the request for the proof of the signer credential and the document are sent simultaneously from the cred-verifying entity to the document-signing entity.

Step S620: The document-signing entity signs the document with a signer private key of the document-signing entity and sends the signed document and the proof of the signer credential to the cred-verifying entity. The proof includes a signer public key paired with the signer private key, In response to the received request and document, the document-signing entity needs to send the signed document and the proof of the signer credential to the cred-verifying entity in return.

Step S630: The cred-verifying entity verifies if the signer credential is authenticated. When the signer credential is verified to be authenticated, perform step S640. Otherwise, perform step S660.

Step S640: The cred-verifying entity verifies if the document is signed by the document-signing entity with the signer public key paired with the signer private key. When the verification result is positive, perform step S650. Otherwise, perform step S660.

Step S650: The cred-verifying entity determines that the document signing succeeds.

Step S660: The cred-verifying entity determines that the document signing fails.

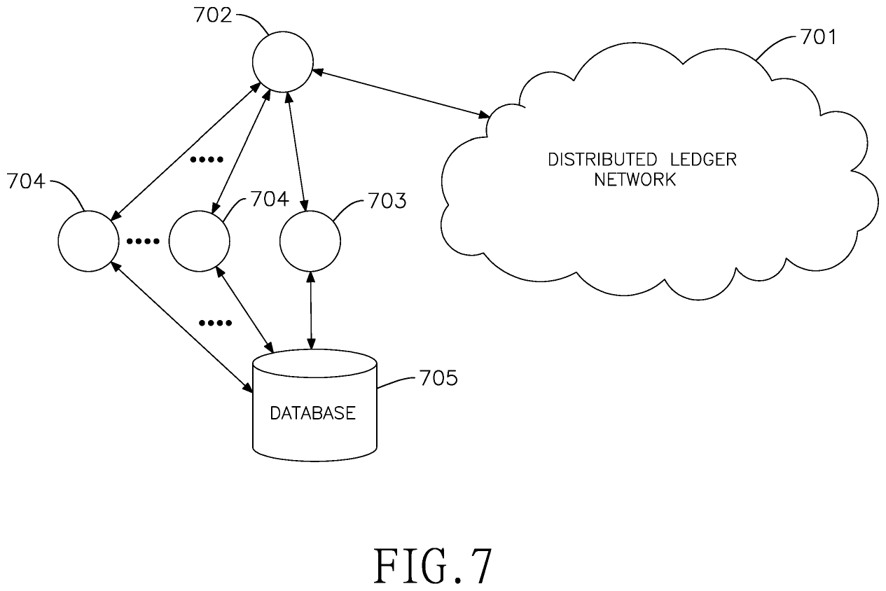

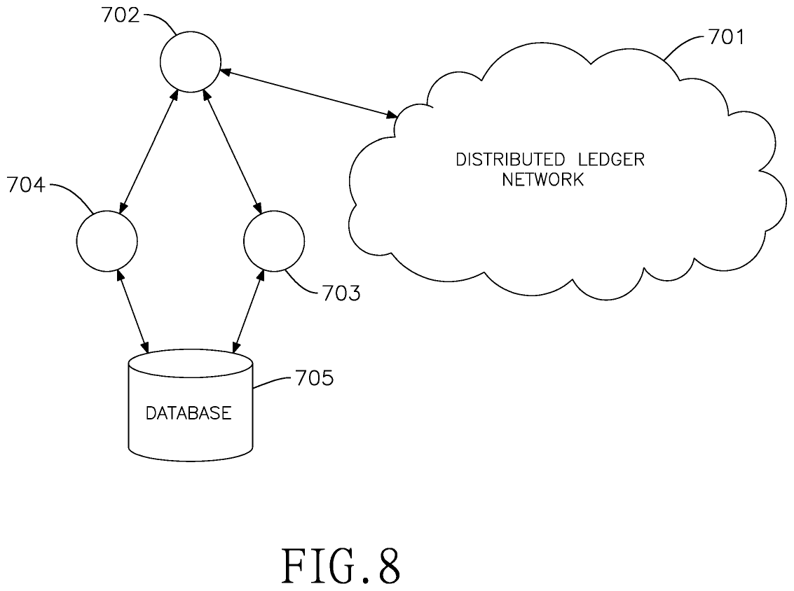

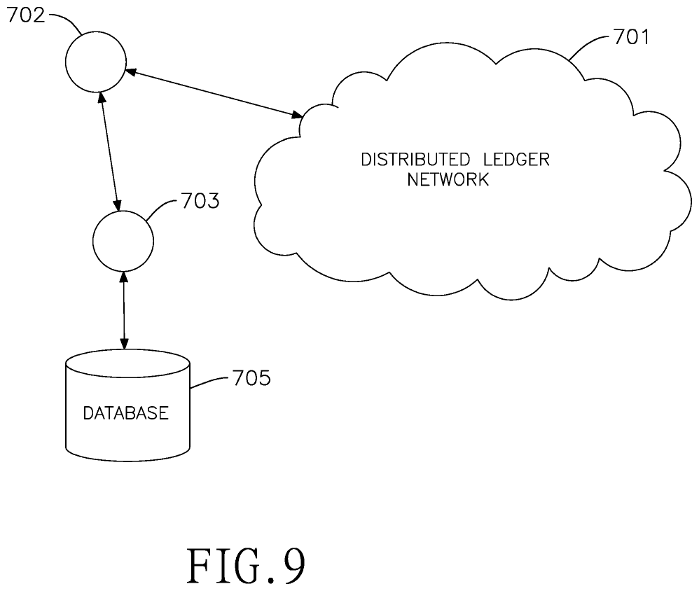

With reference to FIG. 7, a system that can be applied to the first and second subjects includes a distributed ledger network 701, a first computing device 702, a second computing device 703, at least one issuer device 704, and a database 705. The system puts emphasis on structural description in lieu of functions already discussed in the foregoing methods. Although the dots between two issuer devices 704 and those between their links to the first computing device 702 and the database 705 show an embodiment of multiple issuer devices one of which is trusted, the at least one issuer device 704 may also include other embodiments, such as one issuer device which is trusted as shown in FIG. 8 or no issuer device at all as shown in FIG. 9.

The distributed ledger network 701 maintains a distributed ledger storing revocation information associated with issued credentials. The first computing device 702 is communicatively connected to the distributed ledger network 701 and may play the role of the cert-issuing entity in the first subject or the cred-verifying entity in the second subject. The second computing device 703 is communicatively connected to the first computing device 702 and may play the role of the cert-requesting entity in the first subject or the document-signing entity in the second subject. The at least one issuer devices 704 is sort of a flexible part of the system varying with the parent-child issuing relationship, is communicatively connected to the first computing device 702, and is provided and is linked to a credential of the second computing device when the parent-child issuing relationship is available. The parent-child issuing relationship defines that one of the at least one issuer device 704 issues the credential to the second computing device 702 and each of the remaining issuer device 704 issues another credential to another one of the at least one issuer device 704. In other words, the at least one issuer device 704 is not available in the system when the parent-child issuing relationship does not exist. The circumstance of no issuer device 704 may arise from credential forgery and the fake credential results in no issuer device 704 linked to the fake credential according to the parent-child issuing relationship. When the parent-child relationship exists, the at least one issuer device 704 is linked to the credential of the second computing device 703 and the at least one issuer device 704 and the at least one credential thereof are positioned in a credential hierarchy. When being an issuer in the credential hierarchy, each of the first computing device 702, the second computing device 703, and the at least one issuer device 704 can maintain the distributed ledger. The database 705 is communicatively connected to the second computing device 703 and the at least one issuer devices 704 and stores the issued credentials including the credentials of the second computing device 703 and the at least one issuer devices 704 that are respectively accessible to the second computing device 703 and the at least one issuer device 704.

What is worth mentioning is that, if the at least one issuer device 704 is available, upon receiving a request for verifying if the credential of any one of the at least one issuer device 704 is valid when the first computing device 702 verifies if the issuer device 704 is trusted, the issuer device 704 sends a proof according to its credential to the first computing device 702 for verification.

From the foregoing description, the present invention is advantageous in eliminating the tedious and repeated KYC process whenever requesting for issuance of new cert-type credential and verifying digital signature on a document since issuance of a new cert-type credential can be granted and the document signing can be verified with an existing credential regardless of if it is a cert-type credential or a non-cert credential. Besides unnecessity of the KYC process, the credential hierarchy combining a hierarchical structure has multiple credential systems each of which includes either cert-type credentials or non-cert credentials. Users/issuers can acquire different credentials from various credential systems and thus have the freedom in choosing the identities or the user/issuer credentials with the types they prefer. As each issuer in the credential hierarchy of the present invention is capable of maintaining a distributed ledger, the issue of single-point of failure only causes a single and only one credential of an entity compromised and ineffective in the credential hierarchy. For any credential in connection with the compromised credential based on the parent child issuing relationship, the issuer of the credential only suffers from the loss of the credential but can still be identified through other credentials thereof in the credential hierarchy. Moreover, to be qualified as an authenticated credential, it relies on a two-fold verification that the credential is verified to be valid and one of at least one issuer linked to the credential according to the parent-child relationship is verified to be trusted. Such two-fold verification ensures more secure authentication of credentials.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A method for issuing a digital credential of a certificate type, comprising:
(a) a certificate-issuing entity receiving a request for the digital credential of the certificate type from a certificate-requesting entity, wherein the request for the digital credential of the certificate type includes a public key generated by the certificate-requesting entity;
(b) the certificate-issuing entity sending the certificate-requesting entity a request for an existing digital credential of the certificate-requesting entity;
(c) the certificate-issuing entity generating the digital credential of the certificate type including the public key of the certificate-requesting entity after verifying that the existing digital credential is authenticated and the certificate-requesting entity is authentic for endorsing the existing digital credential; and
(d) the certificate-issuing entity sending the digital credential of the certificate type to the certificate-requesting entity.

2. The method as claimed in claim 1, wherein the existing digital credential is of a non-certificate type or the certificate type.

3. The method as claimed in claim 2, wherein when the existing digital credential is of the non-certificate type, the existing digital credential is an official ID digital credential being one of a digital driver license, a digital passport, a digital national ID card, and a digital state ID card.

4. The method as claimed in claim 1, wherein the digital credential of the certificate type is associated with one type of documents.

5. The method as claimed in claim 1, wherein to verify if the existing digital credential is authenticated and the certificate-requesting entity is authentic for endorsing the existing digital credential, the step (c) comprises:
(c1) initializing a current credential and a current credential owner to the existing digital credential and the certificate-requesting entity respectively;
(c2) determining if the current credential is valid;
(c3) when determining that the current credential is valid, determining if an issuer that issues the current credential is available in a digital credential hierarchy and trusted, wherein the issuer is M layer under a credential administrator in the digital credential hierarchy, where M is an integer greater than 0, the issuer is at a next layer above the current credential owner, and owns a digital credential issued by another issuer at a next layer above the issuer, and the credential administrator is at a top layer of the digital credential hierarchy;
(c4) when determining that the issuer is available in the digital credential hierarchy but not trusted, replacing the current credential owner and the current credential with the issuer and a digital credential of the issuer respectively and resuming the step (c2);
(c5) when determining that the issuer is available in the digital credential hierarchy and trusted, determining that the existing digital credential is authenticated and performing step (c7);
(c6) when determining that any determination result of the steps (c2) and (c3) fails, determining that the existing digital credential is not authenticated; and
(c7) when determining that the existing digital credential is authenticated, determining if the certificate-requesting entity is authentic for endorsing the existing digital credential.

6. The method as claimed in claim 5, between the steps (b) and (c), comprising:
(e) the certificate-requesting entity generating a proof for the existing digital credential and providing the proof, the public key, a piece of data, and a digital signature to the certificate-issuing entity, wherein the piece of data is random data generated by the certificate-issuing entity individually or by both the certificate-issuing entity and the certificate-requesting entity, and is signed by a private key generated by the certificate-requesting entity and paired with the public key to generate the digital signature.

7. The method as claimed in claim 6, wherein when determining that the current credential is valid, the step (c2) includes:
(c21) verifying that a proof for the current credential are valid, wherein the proof for the current credential is provided by the current credential owner and includes at least one of an option including at least one public field and at least one digital signatures for the respective public field and another option including at least one zero-knowledge proof challenging at least one challenged field respectively, and a public key associated with the DID of the issuer of the current credential according to a verification requirement document (VRD) from the certificate-issuing entity, and the certificate-issuing entity determines that the current credential is valid by verifying that the at least one option of the at least one digital signature of the at least one public field and the at least one zero-knowledge proof is true; and
(c22) verifying that the current credential is not expired and has not been revoked.

9. The method as claimed in claim 7, wherein in the step (c22), the certificate-issuing entity interacts with a distributed ledger network maintaining a distributed ledger and communicatively connected to the certificate-issuing entity to access revocation information in the distributed ledger and verifies that the current credential has not been revoked according to the revocation information.

11. The method as claimed in claim 6, wherein when determining that the certificate-requesting entity is authentic for endorsing the existing digital credential in the step (c7), the certificate-issuing entity verifies that the digital signature is signed by the certificate-requesting entity with the public key generated by the certificate-requesting entity.

12. The method as claimed in claim 6, wherein in the step (c3), when determining that the issuer in a pre-approved list or the issuer is the credential administrator, the certificate-issuing entity determines that the issuer is trusted.

13. A method for electronically signing a document, comprising:
(f) a credential-verifying entity sending a request for a proof of a signer digital credential of a document-signing entity to the document-signing entity and receiving the proof of the signer digital credential from the document-signing entity, wherein the proof includes a signer public key associated with the signer digital credential;
(g) the credential-verifying entity verifying if the signer digital credential is authenticated and, when verifying that the signer digital credential is valid, sending a document to the document-signing entity; and
(h) the credential-verifying entity receiving the document signed by a signer private key paired with the signer public key and the signer public key from the document-signing entity and verifying if the document is signed by the document-signing entity with the signer public key.

14. The method as claimed in claim 13, wherein the signer digital credential is of a non-certificate type or a certificate type.

15. The method as claimed in claim 14, wherein the signer digital credential is an official ID digital credential being one of a digital driver license, a digital passport, a digital national ID card, and a digital state ID card when the signer digital credential is of the non-certificate type.

16. The method as claimed in claim 14, wherein, in the step (h), the credential-verifying entity receives the document signed by the signer private key associated with a signer decentralized identifier (DID) of the document-signing entity in the signer digital credential and the signer public key paired with the signer private key and verifies if the document is signed by the document-signing entity with the signer public key, when the signer digital credential is of the non-certificate type.

17. The method as claimed in claim 14, wherein, in the step (h), the credential-verifying entity receives the document signed by the signer private key paired with the signer public key in the signer digital credential and the signer public key from the document-signing entity, and verifies if the document is signed by the document-signing entity with the signer public key, when the signer digital credential is of the certificate type.

18. The method as claimed in claim 13, wherein to verify if the signer digital credential is authenticated, the step (g) comprises:
(g1) initializing a current credential and a current credential owner to the signer digital credential and the document-signing entity;
(g2) determining if the current credential is valid;
(g3) when determining that the current credential is valid, determining if an issuer that issues the current credential is available in a digital credential hierarchy and trusted, wherein the issuer is M layer under a credential administrator in the digital credential hierarchy, where M is an integer greater than 0, the issuer is at a next layer above the current credential owner, and owns a digital credential issued by another issuer at a next layer above the issuer, and the credential administrator is at a top layer of the digital credential hierarchy;
(g4) when determining that the issuer is available in the digital credential hierarchy but not trusted, replacing the current credential owner and the current credential with the issuer and a digital credential of the issuer respectively and resuming the step (g2);
(g5) when determining that the issuer is available in the digital credential hierarchy and trusted, determining that the signer digital credential is authenticated; and
(g6) when determining that any determination result of the steps (g2) and (g3) fails, determining that the signer digital credential is not authenticated.

19. The method as claimed in claim 18, wherein when determining that the current credential is valid, the step (g2) includes:
(g21) verifying that a proof for the current credential are valid, wherein the proof for the current credential is provided by the current credential owner and includes at least one of an option including at least one public field and at least one digital signatures for the respective public field and another option including at least one zero-knowledge proof challenging at least one challenged field respectively, and a public key associated with the DID of the issuer of the current credential according to a verification requirement document (VRD) from the credential-verifying entity, and the certificate-issuing entity determines that the current credential is valid by verifying that the at least one option of the at least one digital signature of the at least one public field and the at least one zero-knowledge proof is true; and
(g22) verifying that the digital credential is not expired and has not been revoked.

21. The method as claimed in claim 19, wherein in the step (g22), the credential-verifying entity interacts with a distributed ledger network maintaining a distributed network and communicatively connected to the credential-verifying entity to access revocation information in the distributed ledger and verifies that the current credential has not been revoked according to the revocation information.

23. The method as claimed in claim 13, wherein, the signer digital credential is designated by the credential-verifying entity to be associated with a type of the document.

24. The method as claimed in claim 18, wherein in the step (g3), when determining that the issuer is in a pre-approved list or the issuer is the credential administrator, the credential-verifying entity determines that the issuer is trusted.

25. A method for electronically signing a document, comprising:
(i) a credential-verifying entity sending a request for a proof of a signer digital credential of a document-signing entity and a document to the document-signing entity, wherein the proof includes a signer public key associated with the signer digital credential;
(j) the credential-verifying entity receiving the proof of the signer digital credential and the document signed by a signer private key paired with the signer public key from the document-signing entity; and
(k) the credential-verifying entity verifying if the signer digital credential is authenticated and, when verifying that the signer digital credential is authenticated, verifying that the document is signed by the document-signing entity with the signer public key.

26. The method as claimed in claim 25, wherein the signer digital credential is of a certificate type or a non-certificate type.

27. The method as claimed in claim 26, wherein the signer digital credential is an official ID digital credential being one of a digital driver license, a digital passport, a digital national ID card, and a digital state ID card when the signer digital credential is of the non-certificate type.

28. The method as claimed in claim 26, wherein, at step (j), the credential-verifying entity receives the document signed by the signer private key associated with a signer decentralized identifier (DID) of the document-signing entity in the signer digital credential and the signer public key paired with the signer private key and verifies if the document is signed by the document-signing entity with the signer public key, when the signer digital credential is of the non-certificate type.

29. The method as claimed in claim 26, wherein, at step (j), the credential-verifying entity receives the document signed by the signer private key paired with the signer public key in the signer digital credential and the signer public key from the document-signing entity, and verifies if the document is signed by the document-signing entity with the signer public key, when the signer digital credential is of the certificate type.

30. The method as claimed in claim 25, wherein to verify if the signer digital credential is authenticated, the step (k) comprises:
(k1) initializing a current credential and a current credential owner to the signer digital credential and the document-signing entity;
(k2) determining if the current credential is valid;
(k3) when determining that the current credential is valid, determining if an issuer that issues the current credential is available in a digital credential hierarchy and trusted, wherein the issuer is M layer under a credential administrator in the digital credential hierarchy, where M is an integer greater than 0, the issuer is at a next layer above the current credential owner, and owns a digital credential issued by another issuer at a next layer above the issuer, and the credential administrator is at a top layer of the digital credential hierarchy;
(k4) when determining that the issuer is available in the digital credential hierarchy but not trusted, updating the current credential owner and the current credential with the issuer and a digital credential of the issuer respectively and resuming the step (g2);
(k5) when determining that the issuer is available and trusted, determining that the signer digital credential is authenticated; and
(k6) when determining that any determination result of the steps (k2) and (k3) fails, determining that the signer digital credential is not authenticated.

31. The method as claimed in claim 30, wherein when determining that the current credential is valid, the step (k2) includes:
(k21) verifying that a proof for the current credential is valid, wherein the proof for the current credential is provided by the current credential owner and includes at least one of an option including at least one public field and at least one digital signatures for the respective public field and another option including at least one zero-knowledge proof challenging at least one challenged field respectively, and a public key associated with the DID of the issuer of the current credential according to a verification requirement document (VRD) from the credential-verifying entity, and the certificate-issuing entity determines that the current credential is valid by verifying that the at least one option of the at least one digital signature of the at least one public field and the at least one zero-knowledge proof is true; and
(k22) verifying that the current credential is not expired and has not be revoked.

33. The method as claimed in claim 31, wherein in the step (k22), the credential-verifying entity interacts with a distributed ledger network maintaining a distributed network and communicatively connected to the credential-verifying entity to access revocation information in the distributed ledger and verifies that the current credential has not been revoked according to the revocation information.

35. The method as claimed in claim 25, wherein the signer digital credential is designated by the credential-verifying entity to be associated with a type of the document.

36. The method as claimed in claim 30, wherein in the step (k3), when determining that the issuer is in a pre-approved list or the issuer is the credential administrator, the credential-verifying entity determines that the issuer is trusted.

37. A system for issuing a digital credential of a certificate type and electronically signing a document, comprising:
a distributed ledger network maintaining a distributed ledger storing revocation information associated with issued digital credentials;
a first computing device communicatively connected to the distributed ledger network;
a second computing device communicatively connected to the first computing device;
at least one issuer device provided and linked to a digital credential of the second computing device when a parent-child issuing relationship exists and, when provided, communicatively connected to the first computing device, wherein the parent-child issuing relationship exists when one of the at least one issuer device issues the digital credential to the second computing device and each of the remaining issuer device issues another digital credential to another one of the at least one issuer device; and
a database communicatively connected to the second computing device and the at least one issuer device and storing issued digital credentials including the digital credentials of the second computing device and the at least one issuer device that are respectively accessible to the second computing device and the at least one issuer device.

38. The system of claim 37, wherein the first computing device receives a request for the digital credential of the certificate type from the second computing device, sends a request for an existing digital credential to the second computing device, verifies if the existing digital credential is authenticated and the second computing device is authentic for endorsing the existing digital credential and, when verifying that the existing digital credential is authenticated and the second computing device is the authentic for endorsing the existing digital credential, generates the digital credential of the certificate type, and sends the digital credential of the certificate type to the second computing device, wherein the request for the digital credential of the certificate type includes a public key generated by the second computing device.

39. The system as claimed in claim 38, wherein the existing digital credential is of a non-certificate type or the certificate type.

40. The system as claimed in claim 39, wherein when the existing digital credential is of the non-certificate type, the existing digital credential is an official ID digital credential being one of a digital driver license, a digital passport, a digital national ID card, and a digital state ID card.

41. The system as claimed in claim 38, wherein the digital credential of the certificate type is associated with one type of documents.

42. The system as claimed in claim 38, wherein when verifying if the existing digital credential is authenticated and the second computing device is authentic for endorsing the existing digital identity, the first computing device initializes a current credential and a current credential owner to the existing digital credential and the second computing device, determines if the current credential is valid, when determining that the current credential is valid, determining if one of the at least one issuer device that issues the current credential is available in a digital credential hierarchy and trusted, when determining that the issuer device is available in the digital credential hierarchy but not trusted, replaces the current credential owner and the current credential with the issuer device and a digital credential of the issuer device respectively and recursively loops back to determine if the current credential is valid until the issuer device is available in the digital credential hierarchy and trusted or is not available in the digital credential hierarchy, when determining that the issuer device is available in a digital credential hierarchy and trusted, determines that the existing digital credential is authenticated, and when determining that the existing digital credential is authenticated, determines if the second computing device is authentic for endorsing the existing digital credential;
wherein the issuer device or its digital credential is M layer under a credential administrator in the digital credential hierarchy, where M is an integer greater than 0, the issuer device or its digital credential is at a next layer above the current credential owner or its digital credential, the issuer device owns the digital credential issued by another one of the at least one issuer device at a next layer above the issuer device, and the credential administrator or its digital credential is at a top layer of the digital credential hierarchy.

43. The system as claimed in claim 42, wherein after the first computing device sends the request for the existing digital credential and the public key to the second computing device, the second computing device generates a proof for the existing digital credential and provides the proof for the existing digital credential, the public key, a piece of data, and a digital signature to the first computing device, wherein the piece of data is random data generated by the first computing device individually or by both the first computing device and the second computing device, and is signed by the second computing device with a private key generated by the second computing device and paired with the public key to generate the digital signature.

44. The system as claimed in claim 43, wherein when determining that the current credential is valid, the first computing device verifies that a proof for the current credential is valid and then verifies that the current credential is not expired and has not be revoked;
wherein the proof for the current credential is provided by the current credential owner and includes at least one of an option including at least one public field and at least one digital signatures for the respective public field and another option including at least one zero-knowledge proof challenging at least one challenged field respectively, and a public key associated with the DID of the issuer of the current credential according to a verification requirement document (VRD) from the first computing device, and the first computing device determines that the current credential is valid by verifying that the at least one option of the at least one digital signature of the at least one public field and the at least one zero-knowledge proof is true.

46. The system as claimed in claim 44, wherein the first computing device interacts with the distributed ledger network to access revocation information in the distributed ledger and verifies that the current credential to be verified has not been revoked according to the revocation information.

48. The system as claimed in claim 43, wherein when determining that the second computing device is authentic for endorsing the existing digital credential, the first computing device verifies that the digital signature is signed by the second computing device with the public key generated by the second computing device.

49. The system as claimed in claim 42, wherein when determining that the issuer device is trusted, the first computing device determines that the issuer device is in a pre-approved list or the issuer device is the credential administrator.

50. The system as claimed in claim 37, wherein the first computing device sends the request for a proof of a signer digital credential of the second computing device to the second computing device, receives the proof of the signer digital credential from the second computing device, verifies if the signer digital credential is authenticated and, when verifies that the signer digital credential is authenticated, sends a document to the second computing device, receives the document signed by a signer private key paired with a signer public key included in the proof and associated with the signer digital credential and the signer public key from the second computing device, and verifies if the document is signed by the second computing device with the signer public key.

51. The system as claimed in claim 50, wherein the signer digital credential is of the non-certificate type or the certificate type.

52. The system as claimed in claim 51, wherein the signer digital credential is an official ID digital credential being one of a digital driver license, a digital passport, a digital national ID card, and a digital state ID card.

53. The system as claimed in claim 51, wherein the first computing device receives the document signed by the signer private key associated with a signer decentralized identifier (DID) of the second computing device in the signer digital credential and the signer public key paired with the signer private key and verifies if the document is signed by the second computing device with the signer public key, when the signer digital credential is of the non-certificate type.

54. The system as claimed in claim 51, wherein the first computing device receives the document signed by the signer private key paired with the signer public key in the signer digital credential and the signer public key from second computing device, and verifies if the document is signed by the second computing device with the signer public key, when the signer digital identity is of the certificate type.

55. The system as claimed in claim 51, wherein when the signer digital credential is of the certificate type and the first computing device determines that the signer digital credential is authenticated, the first computing device initializes a current credential and a current credential owner to the signer digital credential and the second computing device, determines if the current credential is valid, when determining that the current credential is valid, determines if one of the at least one issuer device that issues the current identity is available in a digital credential hierarchy and trusted, when determining that the issuer device is available in the digital credential hierarchy but not trusted, replaces the current credential owner and the current credential with the issuer device and a digital credential of the issuer device respectively and recursively loops back to determine if the current credential is valid until the issuer device is available in the digital credential hierarchy and trusted or is not available in the digital credential hierarchy, when determining that the issuer device is available in the digital credential hierarchy and trusted, determines that the signer digital credential is authenticated;
wherein the issuer device or its digital credential is M layer under a credential administrator in the digital credential hierarchy, where M is an integer greater than 0, the issuer device or its digital credential is at a next layer above the current credential owner or its digital credential, the issuer device owns the digital credential issued by another one of the at least one issuer device at a next layer above the issuer device, and the credential administrator or its digital credential is at a top layer of the digital credential hierarchy.

56. The system as claimed in claim 55, wherein when determining that the current credential is authenticated, the first computing device verifies that a proof for the current credential is valid and then verifies that the current credential is not expired and has not be revoked;
wherein the proof for the current credential is provided by the current credential owner and includes at least one of an option including at least one public field and at least one digital signatures for the respective public field and another option including at least one zero-knowledge proof challenging at least one challenged field respectively, and a public key associated with the DID of the issuer device of the current credential according to a verification requirement document (VRD) from the first computing device, and the first computing device determines that the current credential is valid by verifying that the at least one option of the at least one digital signature of the at least one public field and the at least one zero-knowledge proof is true.

58. The system as claimed in claim 56, wherein the first computing device interacts with the distributed ledger network to access revocation information in the distributed ledger and verifies that the current credential to be verified has not been revoked according to the revocation information.

60. The system as claimed in claim 50, wherein the first computing device designates that the signer digital credential is associated with a type of the document.

61. The system as claimed in claim 55, wherein when determining that the issuer device is trusted, the first computing device determines that the issuer device is in a pre-approved list or the issuer device is the credential administrator.

62. The system as claimed in claim 37, wherein the first computing device sends a request for a proof of a signer digital credential and a document to the second computing device, receives the proof of the signer digital credential and the document signed by a signer private key paired with a signer public key paired included in the proof from the second computing device, verifies if the signer digital credential is authenticated, and when verifying that the signer digital credential is authenticated, verifies if the document is signed by the second computing device with the signer public key.

63. The system as claimed in claim 62, wherein the signer digital credential is of the non-certificate type or the certificate type.

64. The system as claimed in claim 63, wherein the signer digital credential is an official ID digital credential being one of a digital driver license, a digital passport, a digital national ID card, and a digital state ID card.

65. The system as claimed in claim 63, wherein the first computing device receives the document signed by the signer private key associated with a signer decentralized identifier (DID) of the second computing device in the signer digital credential and the signer public key paired with the signer private key and verifies if the document is signed by the second computing device with the signer public key, when the signer digital credential is of the non-certificate type.

66. The system as claimed in claim 63, wherein the first computing device receives the document signed by the signer private key paired with the signer public key in the signer digital credential and the signer public key from the second computing device, and verifies if the document is signed by the second computing device with the signer public key, when the signer digital credential is of the certificate type.

67. The system as claimed in claim 63, wherein when the first computing device determines that the signer digital identity is authenticated, the first computing device initializes a current credential and a current credential owner to the signer digital credential and the second computing device, determines if the current credential is valid, when determining that the current credential is valid, determines if one of the at least one issuer device that issues the current credential is available in a digital credential hierarchy and trusted, when determining that the issuer device is available but not trusted, replaces the current credential owner and the current credential with the issuer device and a digital credential of the issuer device respectively and recursively loops back to determine if the current credential is valid until the issuer device is available in the digital credential hierarchy and trusted or is not available in the digital credential hierarchy, when determining that the issuer device is available in the digital credential hierarchy and trusted, determines that the signer digital credential is authenticated;
wherein the issuer device or its digital identity is M layer under a credential administrator in the digital credential hierarchy, where M is an integer greater than 0, the issuer device or its digital credential is at a next layer above the current credential owner or its digital credential, the issuer device owns the digital credential issued by another one of the at least one issuer device at a next layer above the issuer device, and the credential administrator or its digital credential is at a top layer of the digital credential hierarchy.

68. The system as claimed in claim 67, wherein when determining that the current credential is valid,
the first computing device verifies that a proof for the current credential is valid and then verifies that the current credential is not expired and has not be revoked;
wherein the proof for the current credential is provided by the current credential owner and includes at least one of an option including at least one public field and at least one digital signatures for the respective public field and another option including at least one zero-knowledge proof challenging at least one challenged field respectively, and a public key associated with the DID of the issuer device of the current credential according to a verification requirement document (VRD) from the first computing device, and the first computing device determines that the current credential is valid by verifying that the at least one option of the at least one digital signature of the at least one public field and the at least one zero-knowledge proof is true.

70. The system as claimed in claim 68, wherein the first computing device interacts with the distributed ledger network to access revocation information in the distributed ledger and verifies that the current credential to be verified has not been revoked according to the revocation information.

72. The system as claimed in claim 62, wherein the first computing device designates that the signer digital credential is associated with a type of the document.

73. The system as claimed in claim 67, wherein when determining that any of the at least one issuer device is trusted, the first computing device determines that the issuer device is in a pre-approved list or the issuer device is the credential administrator.
